(19) United States
(12) Patent Application Publication
(10) Pub. No.: US 2019/0276113 A1
(43) Pub. Date: Sep. 12, 2019

(54) SEPARATING DEVICE, HYDRAULIC BRAKING SYSTEM, VEHICLE, AND METHOD FOR OPERATING A BRAKING SYSTEM

(71) Applicant: Robert Bosch GmbH, Stuttgart (DE)

(72) Inventors: Till MERKLE, Stuttgart (DE); Rinaldo GREINER, Reutlingen (DE)

(21) Appl. No.: 16/463,712

(22) PCT Filed: Nov. 13, 2017
(86) PCT No.: PCT/EP2017/079000

§ 371 Date: May 23, 2019

(30) Foreign Application Priority Data
Nov. 30, 2016 (DE) 10 2016 223 735.7

(51) Int. Cl. B62L 3/02; B62L 3/06; B62H 5/00; B62H 5/18; B60T 8/17

(52) U.S. Cl. CPC B62L 3/023; B62L 3/06; B60T 8/1706; B62H 5/18; B62H 5/00

(57) ABSTRACT

A separating device for a hydraulic braking system of a vehicle provides a normal braking operating state in which a section upstream and on a reservoir side of a brake line and a section downstream and on the brake side of the brake line are hydraulically connected, and provides a separating operating state in which those sections are hydraulically separated from each other. A hydraulic valve includes a housing and a slide element for the controlled hydraulic connection and separation, the slide element being displaceable in the housing between a first position corresponding to the normal braking operating state and a second position corresponding to the separating operating state. The hydraulic valve is configured to displace the slide element into the second position in a controlled manner via a pressure prevailing in a pressure accumulator.

### CROSS-REFERENCE TO RELATED APPLICATIONS

The present application is the national stage of International Pat. App. No. PCT/EP2017/079000 filed Nov. 13, 2017, and claims priority under 35 U.S.C. § 119 to DE 10 2016 223 735.7, filed in the Federal Republic of Germany on Nov. 30, 2016, the content of each of which are incorporated herein by reference in their entireties.

### FIELD OF THE INVENTION

The present invention relates to a separating device, a hydraulic braking system, a vehicle, and a method for operating a hydraulic braking system. The present invention relates in particular to a separating device for a hydraulic braking system, in particular for a vehicle, a bicycle, electric bicycle, e-bike, or pedelec drivable using muscular power and/or motor power, to such a hydraulic braking system, and to a bicycle, electric bicycle, e-bike, pedelec, or the like having such a hydraulic braking system.

### BACKGROUND

In the field of bicycles, electric bicycles, e-bikes, pedelecs, or the like, hydraulic braking systems are increasingly used for braking the particular vehicle because the braking effect of such braking systems is particularly reliable.

However, it is problematic that the dynamic pressure range required for specific functions includes pressures which cannot be maintained for a sufficiently long time or sufficiently reliably using conventional hydraulic braking systems, in particular in the area of the brake lever unit. This relates, for example, to functions of brake assist systems and theft protection.

### SUMMARY

According to an example embodiment, a separating device is provided that has an advantage over the related art in that pressure ranges having higher pressures can also be maintained for a long time span by decoupling weak points of a braking system. This is achieved in that a separating device is provided for a hydraulic braking system, in particular for a vehicle drivable using muscular power and/or motor power, a bicycle, electric bicycle, e-bike, pedelec, or the like, in which (i) in a normal braking operating state, a section of a brake line of the braking system located upstream and on the reservoir side and a section of the brake line of the braking system located downstream and on the brake side are hydraulically connected and (ii) in a separating operating state, the section of the brake line located upstream and on the reservoir side and the section of the brake line located downstream and on the brake side are hydraulically separated from one another. A particularly high degree of reliability and operational safety of the separating device according to the present invention results in that (iii) a hydraulic valve including a housing and a slide element is designed for the controlled connection and separation, (iv) the slide element being displaceable in a controllable manner in the housing between a first position corresponding to the normal braking operating state and a second position corresponding to the separating operating state. The hydraulic valve is configured (v) to displace the slide element via a pressure prevailing in an associated pressure accumulator into the second position corresponding to the separating operating state. In the separating operating state, the first section of the brake line of this area located upstream and on the reservoir side is depressurized by hydraulic decoupling. In contrast, it is possible to maintain pressure and work with pressures in the section of the brake line located downstream and on the brake side for which the first section of the brake line located upstream and on the reservoir side is not designed. In this way, functions of a brake assist system and/or theft protection can also be implemented using a correspondingly refined braking system.

The hydraulic valve can be designed, for example, as a volume flow slider or as a piston valve.

The normal braking operating state and the separating operating state of the separating device can be implemented in a particularly simple manner if, according to an example embodiment of the separating device, the housing of the hydraulic valve includes a first main opening located upstream and on the reservoir side and a second main opening located downstream and on the brake side, in particular for hydraulic connection to the brake line of the braking system, (i) in the first position of the slide element, the first and second main openings of the housing being hydraulically connected and coupled and (ii) in the second position of the slide element, the first and second main openings of the housing being hydraulically separated and decoupled.

The controllability by the control unit via the operation of the volume flow slider can be designed particularly reliably if, according to an example embodiment of the separating device, the housing of the hydraulic valve includes a control opening for the hydraulic control of the position of the slide element, in particular via an—indirect or direct—hydraulic connection or separation to or from the associated pressure accumulator, preferably using or in a control line.

It is particularly advantageous if the separating device is designed having a first control valve, which is designed for the controlled hydraulic connection and separation of the control opening of the hydraulic valve to/from the section of the brake line located upstream and on the reservoir side, preferably using a bypass line, which in particular opens into the section of the brake line located upstream and on the reservoir side and is hydraulically connected or connectable to the control opening of the hydraulic valve.

Additionally or alternatively, an example embodiment of the separating device has a—possibly second—control valve, which is configured for the controlled hydraulic connection and separation of the control opening of the hydraulic valve to or from the associated pressure accumulator, in particular using a or the control line and/or using a or the bypass line, which in particular opens into the section of the brake line located upstream and on the reservoir side and is hydraulically connected or connectable to the control opening of the hydraulic valve.

To increase the operational reliability of the separating device according to the present invention, in an example embodiment, a particular control valve, e.g., in particular the first control valve and/or the second control valve, is or includes a normally-closed valve, in particular a deenergized closed solenoid valve.

According to an example embodiment, the separating device is provided with an evaluation and control unit, which is designed to control the state of the separating device, in particular via a control of the state of the first control valve and/or the second control valve and/or via a detection and evaluation of signals of one or multiple sensors.

To avoid access to the separating device according to the present invention by an unauthorized person, in an example embodiment, the separating device is designed having an authentication unit, via which, in particular, an existing separating operating state of the separating device and in particular a blocking of a brake of the underlying braking system can be canceled or unblocked only using an authorization means, in particular in cooperation with a or the evaluation and control unit.

It is particularly advantageous if the authentication unit and/or the authentication means are implemented in conjunction with a WLAN unit, a Bluetooth unit, an RFID means, a PIN means, a password protection, a protection via biometric features, or the like, in particular in conjunction with an ultrasound, infrared, and/or radio communication, preferably using a mobile telephone.

Furthermore, the present invention also relates to a hydraulic braking system for a vehicle drivable using muscular power and/or motor power, and in particular for a bicycle, electric bicycle, e-bike, pedelec, or the like, including a reservoir for a brake fluid, a brake, a brake line for hydraulic connection of the reservoir to the brake and a separating device according to the present invention, which is integrated into the brake line.

According to a further aspect of the present invention, a vehicle drivable using muscular power and/or motor power, and in particular a bicycle, electric bicycle, e-bike, pedelec, or the like is provided including at least one wheel and a hydraulic braking system according to the present invention for braking and/or blocking the wheel.

Furthermore, the present invention also provides a method for operating a hydraulic braking system, in particular for a vehicle drivable using muscular power and/or motor power, for example, a bicycle, electric bicycle, e-bike, pedelec, or the like.

In the method, in a normal braking operating state, a section of a brake line of the braking system located upstream and on the reservoir side and a section of the brake line of the braking system located downstream and on the brake side are hydraulically connected and, in a separating operating state, the section of the brake line located upstream and on the reservoir side and the section of the brake line located downstream and on the brake side are hydraulically separated from each other.

In a hydraulic valve including a housing and a slide element, the slide element is displaced in the housing in a controlled manner between a first position corresponding to the normal braking operating state and a second position corresponding to the separating operating state.

The slide element is displaced, controlled via a pressure prevailing in an associated pressure accumulator, into the second position corresponding to the separating operating state.

Example embodiments and the technical context of the present invention are described in detail hereafter with reference to FIGS. 1-6 of the appended drawings, in which identical and equivalent and identically or equivalently acting elements and components are identified by the same reference numerals. The detailed description of the identified elements and components is not reproduced every time they appear. The illustrated features and further properties can be isolated from one another and combined with one another, without departing from the core concept of the present invention.

### BRIEF DESCRIPTION OF THE DRAWINGS

FIG. 1 is a schematic view of an example of a vehicle as an electric bicycle according to an example embodiment of the present invention.

FIG. 2 shows a schematic view as a block diagram of a separating device in conjunction with a hydraulic braking system, according to an example embodiment of the present invention.

FIGS. 3 and 4 are block diagrams of a hydraulic braking system including a separating device in a braking operating state and in a separating operating state, respectively, according to an example embodiment of the present invention.

FIGS. 5 and 6 show, in greater detail, the volume flow slider underlying the blocking device from FIGS. 3 and 4 in the braking operating state and in the separating operating state, respectively, of the separating device, according to an example embodiment of the present invention.

### DETAILED DESCRIPTION

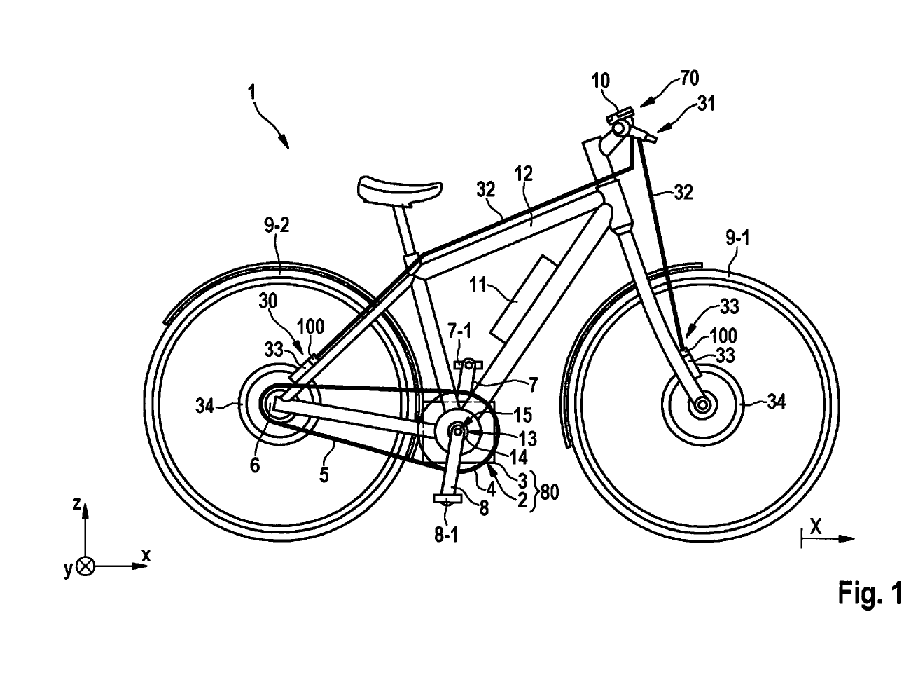

Firstly, an electric bicycle is described by way of example in detail as a preferred example embodiment of vehicle 1 with reference to FIG. 1. Vehicle 1, as an electric bicycle, encompasses a frame 12, on which a front wheel 9-1, a rear wheel 9-2, and a crankset 2 including two cranks 7, 8 and pedals 7-1 and 8-1 are situated. An electric drive 3 is integrated into crankset 2. A pinion 6 and possibly a gearshift are situated on rear wheel 9-2. Crankset 2 and electric drive 3 form drive 80 of vehicle 1.

A drive torque, which is provided by the rider and/or by electric drive 3, is transmitted by a chainwheel 4 on crankset 2 via a chain 5 to pinion 6.

In this example embodiment, a control unit 10, which is connected to electric drive 3, is furthermore situated on handlebars 17 of vehicle 1. Control unit 10 can also be implemented at another point. Furthermore, battery 11, which is used for the power supply of electric drive 3, is formed in or on frame 12.

Furthermore, a crank bearing 13 or bottom bracket ball bearing, which includes a crank housing 14 and a crankshaft 15, is integrated into frame 12.

An example embodiment of separating device 100 is also provided in the area of a braking system 30, using which an access to brake disks 34 can be initiated via brake lines 32 upon actuation of brake lever 31 via brakes 33, either for one of brakes 33 or for both brakes 33. In the view of FIG. 1, braking system 30 has a separate separating device 100 in the area of each of brakes 33. However, this is not imperative.

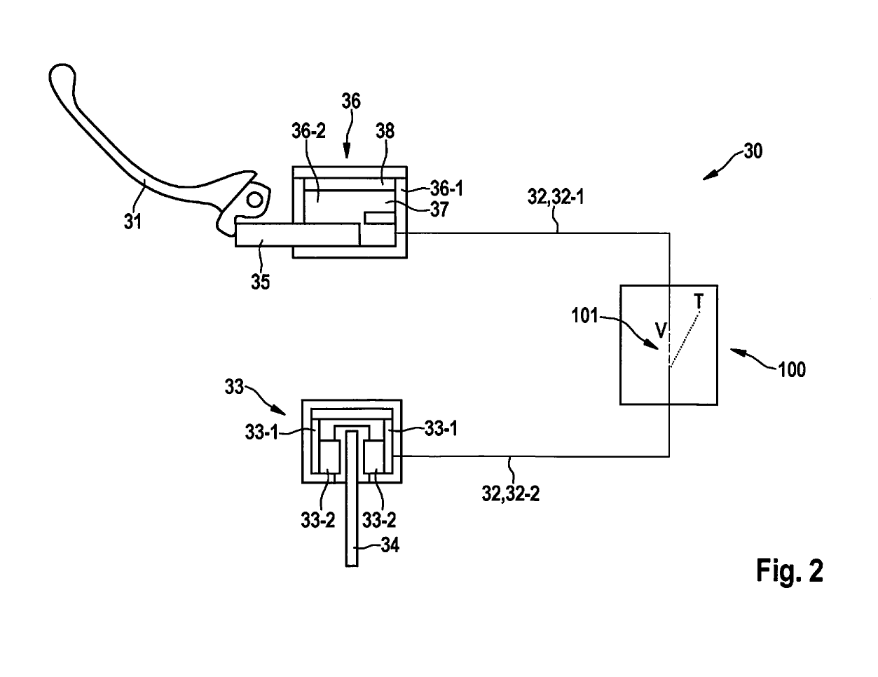

FIG. 2 schematically shows, as a block diagram, an example embodiment of hydraulic braking system 30 designed with a separating device 100. Hydraulic braking system 30 includes a brake line 32, which hydraulically, i.e., fluidically, connects an actuator made of brake lever 31 and reservoir 36 for a brake fluid 37 to actual brake 33.

Brake 33 itself is made up of brake caliper 33-1 and brake pads 33-2, which are moved upon actuation of brake lever 31 by a user due to the hydraulic connection via brake line 32 in such a way that they enclose brake disk 34 between them, thus applying friction to brake disk 34, and thus stop, block, or if necessary decelerate brake disk 34 and particular wheel 9-1, 9-2 of vehicle 1 connected to brake disk 34.

For particularly flexible modulation of the brake pressure and/or to implement a brake assist function and/or a blocking function, which is also referred to as a locking function, an example embodiment of separating device 100 is introduced into brake line 32, so that brake line 32 is divided into a first section 32-1 located on the reservoir side and upstream and a second section 32-2 located on the brake side and downstream.

To implement the braking operating state and the separating operating state, the separating device includes a separating element 101, which, in FIG. 2 in position V, implements the hydraulically connected state in brake line 32, i.e., the normal braking operating state, and therefore allows the unobstructed hydraulic connection between brake 33 and reservoir 36, which is also referred to as a cylinder.

Separating element 101 is additionally capable of assuming a position T, in which first section 32-1 of brake line 32 and second section 32-2 of brake line 32 are hydraulically decoupled or separated from each other, second section 32-2 being able to be locked pressure-tight, so that the pressure in second section 32-2 of brake line 32, which is located on the brake side and downstream, is maintained without requiring the components in section 32-1 of brake line 32, which is located upstream and on the reservoir side. In this way, for example, brake 33 can be locked and remain blocked in a braking state in which brake pads 33-2 block the brake disk from movement. Alternatively or additionally, pressure modulations in the meaning of a brake assist are conceivable in this state independent of section 32-1 located upstream.

To actuate brake 33, brake lever 31 is connected to a piston 35, which displaces volume in reservoir or cylinder 36 upon actuation of lever 31 and thus forces brake fluid 37 out of the interior of cylinder 36 into brake line 32. The pressure thus resulting is transmitted hydraulically toward brake 33 in brake line 32 and results in a movement of brake pads 33-2 toward brake disk 34.

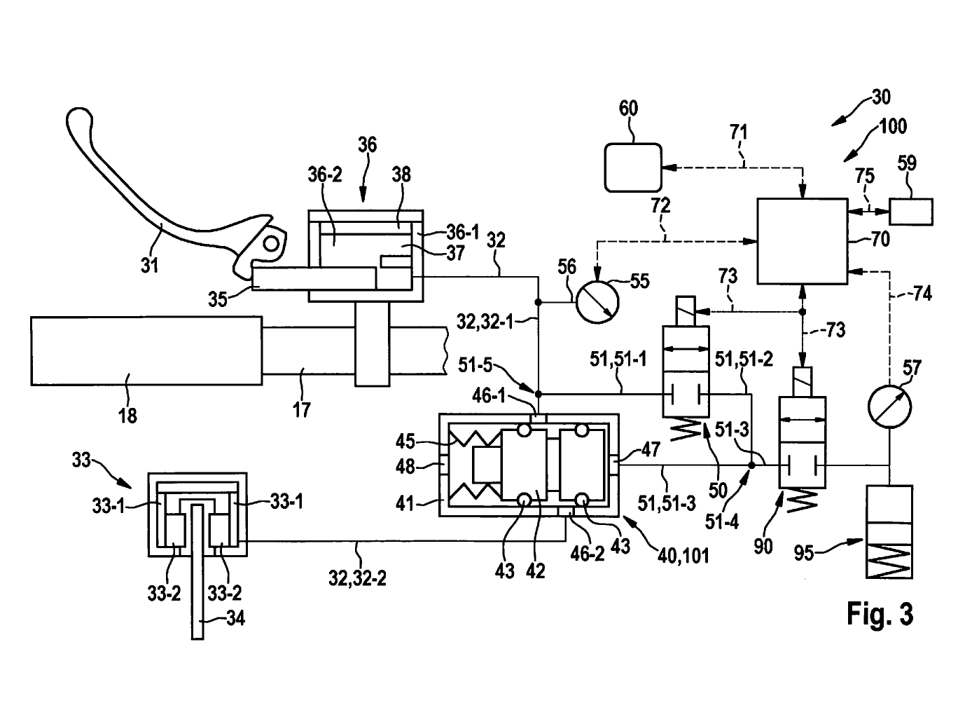

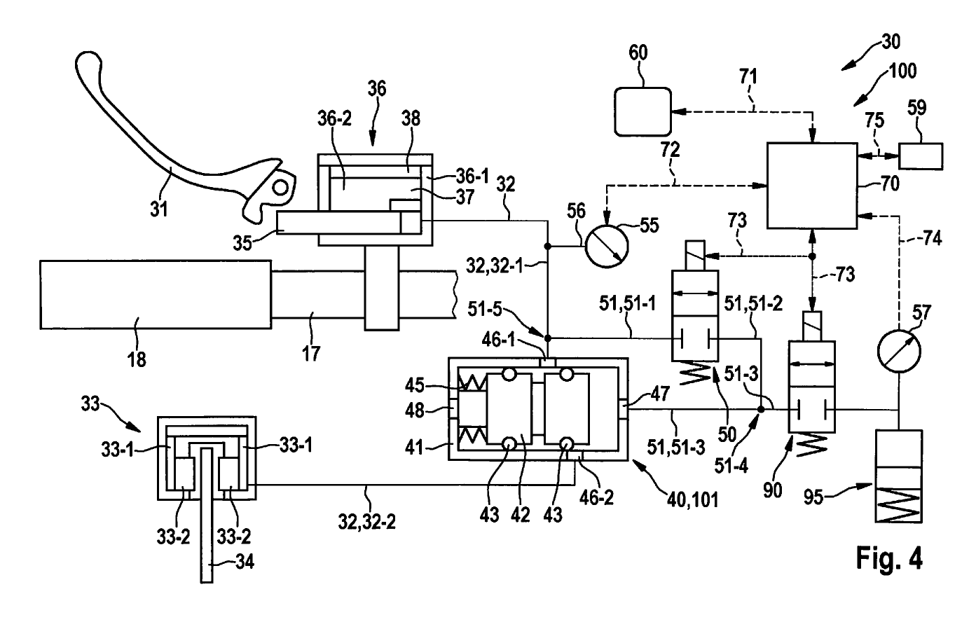

FIGS. 3 and 4 show, in the form of block diagrams in a normal braking operating state and a separating operating state, respectively, an example embodiment of hydraulic braking system 30, details of the example embodiment of employed separating device 100 according to the present invention including a hydraulic valve 40 as separating element 101 also being shown.

Braking system 30 is made up of reservoir or cylinder 36 including brake fluid 37 in the interior 36-2 of its housing 36-1 with additional provision of a compensation volume 38.

Cylinder 36 is connected via brake line 32 to actual brake 33. Brake 33 is made up of brake caliper 33-1 and brake pads 33-2, which are guided in brake caliper 33-1 and are capable of applying friction to brake disk 34 situated therebetween by movement toward each other. This takes place precisely when, due to actuation of brake lever 31, piston 35 in reservoir 36 forces brake fluid 37 into brake line 32, pressure being thus transmitted via brake line 32 toward brake 33 and a movement being forced of brake pads 33-2 toward brake disk 34.

Brake lever 31 and reservoir 36 are attached, in the view of FIGS. 3 and 4, adjacent to handle 18 on handlebars 17 of underlying vehicle 1. However, other arrangements are also conceivable, for example, with brakes 33 actuatable using a foot pedal or the like.

An example embodiment of separating device 100 is formed in brake line 32, which divides brake line 32 into a first section 32-1 located upstream and on the reservoir side and a second section 32-2 located downstream and on the brake side.

The example embodiment of separating device 100 as shown in FIGS. 3 and 4 includes a hydraulic valve 40 in the form of a volume flow slider, a first control valve 50, a second control valve 90, and a pressure accumulator 95. Volume flow slider 40 is designed to either enable a hydraulic connection of reservoir 36 and brake 33 via brake line 32 in a normal braking operating state or prevent it in a separating operating state, second control valve 90 being used to control the operation of volume flow sider 40 by either establishing or preventing a connection to pressure accumulator 95. This takes place by pressure from pressure accumulator 95 being applied if necessary via a control line 51-3 to control opening 47 of hydraulic valve 40 for controlled movement of slide element 42 in housing 41 of hydraulic valve 40.

First control valve 50 is formed in a bypass line 51 that opens at an outlet point 51-5 into brake line 32 and in particular into its first section 32-1 located upstream and on the reservoir side.

Furthermore, a second outlet point 51-4 is provided, at which control line 51-3 and bypass line 51 merge into each other.

First control valve 50 provides, on the one hand, a controllable hydraulic connection or separation of first section 32-1 of brake line 32, which is located upstream and on the reservoir side, to or from control opening 47 of hydraulic valve 40 and, on the other hand, in cooperation with second control valve 90, a controllable hydraulic connection or separation of first section 32-1 of brake line 32, which is located upstream and on the reservoir side, to or from associated pressure accumulator 95. This controllable hydraulic connection and separation can be used, for example, to charge pressure accumulator 95 with brake fluid 37 under pressure by way of a pumping movement on brake lever 31, to collect pressure from brake line 32 as a whole in pressure accumulator 95 and/or to accommodate pressure from brake 33 in pressure accumulator 95 and/or in reservoir 36.

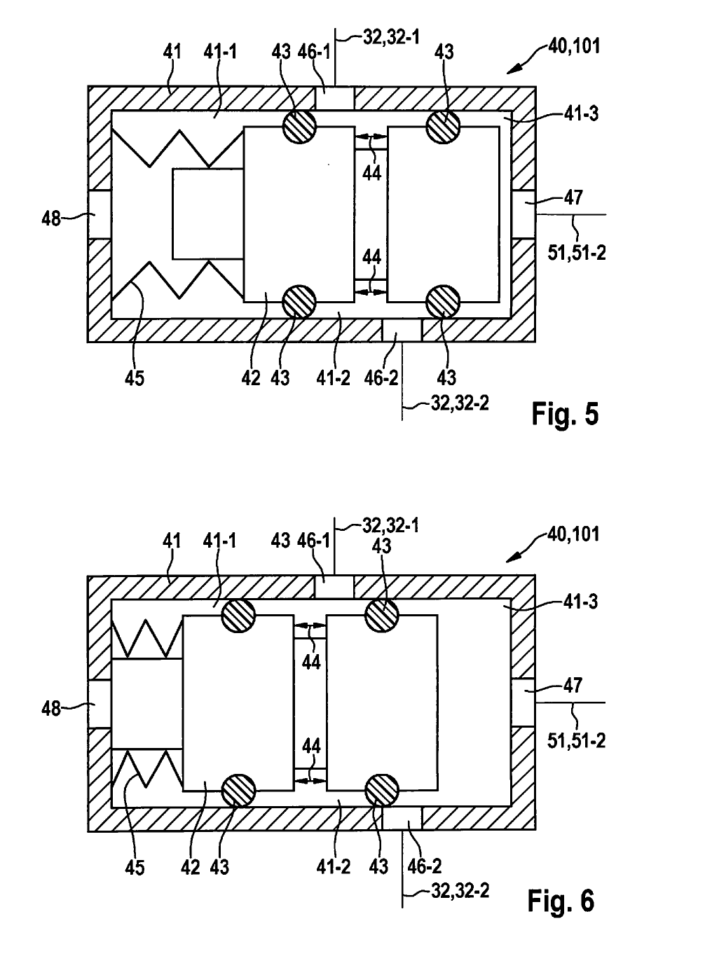

FIGS. 5 and 6 show, in the form of schematic block diagrams, details of hydraulic valve 40 in the form of a volume flow slider, specifically in the states according to FIGS. 3 and 4, respectively. Volume flow slider 40 includes a housing 41, in the interior of which a slide element 42 is displaceably mounted to form a seal via seals 43. Slide element 42 is spring-loaded via a restoring element 45 in the form of a spring to ensure an unobstructed hydraulic connection of reservoir 36 to brake 33, i.e., a continuous fluid communication in brake line 32, in the non-actuated state of volume flow slider 40.

For this purpose, housing 41 of volume flow slider 40 has a reservoir-side main opening 46-1 and a brake-side main opening 46-2. Via seals 43 and the design of slide element 42 including groove 44, in the position of slide element 42 shown in FIGS. 3 and 5, a continuous fluid communication and thus a hydraulic connection exists in an entire brake line 32 from reservoir 36 to brake 33. This means that the interior of housing 41 and in particular so-called brake compartment 41-2 can have brake fluid 37 flow through it freely via brake line 32 from reservoir 36 toward brake 33.

The state of volume flow slider 40 shown in FIG. 3 is shown once again in greater detail in FIG. 5. The division resulting due to slide element 42 and its seals 43 of the interior of housing 41 into first or compensation compartment 41-1, second or brake compartment 41-2, and third or blocking compartment 41-3 is also shown in detail therein.

For the actuation of volume flow slider 40 and in particular for the movement of slide element 42 against the spring force of restoring element 45, a control opening 47 is formed on the right end side of housing 41 of volume flow slider 40, via which a control fluid can be supplied using a bypass line 51, which collects in control compartment 41-3 and shifts slide element 42 by displacement from the position shown in FIGS. 3 and 5 to the left into the position shown in FIGS. 4 and 6.

Due to this shift, the hydraulic connection in brake line 32 is interrupted by the free communication being interrupted between first and second main openings 46-1 and 46-2. This is shown in detail in FIG. 6.

A transition from the normal brake operation to the separating operation takes place with the movement of slide element 42.

In the illustration according to FIGS. 3-6, line 51 guided to control opening 47 of housing 41 of volume flow slider 40 is a bypass line 51, which partially extends together with control line 51-3 and to which brake fluid 37 is applied from pressure accumulator 95 or which can discharge pressure into pressure accumulator 95.

This application of brake fluid 37 from pressure accumulator 95 takes place, however, only upon activation of second control valve 90, e.g., in particular in its energized case. In the deenergized case—and thus inherently safe—the second control valve is closed and no influence of volume flow slider 40 and its slide element 42 takes place, which remains in the position shown in FIGS. 3 and 5. Slide element 42 is only pushed into the separating operating position in the energized case according to FIGS. 4 and 6, so that brake line 32 is hydraulically interrupted and, for example, while maintaining the brake pressure in second section 32-2 located downstream and on the brake side, the braking effect of brake pads 33-2 on brake disk 34 to block brake disk 34 is maintained.

The control of separating device 100 and braking system 30 according to FIGS. 3-6 can be carried out using an evaluation and control unit 70. In the illustration according to FIGS. 3 and 4, it is connected via control and measuring lines 71, 72, 73, 74, and 75 to an authentication unit 60, pressure measuring sensors 55, 57, further sensor 59, and control valves 50 and 90.

Evaluation and control unit 70 can be designed, for example, to only actuate control valves 50 and/or 90, e.g., open them by application of electrical current, for example, if pressures or other operating parameters determined by sensors 55, 57, 59 are present during the operation of vehicle 1 and/or braking system 30.

On the other hand, a re-actuation of control valves 50 and/or 90 for unblocking by canceling the separating operating state and thus a transition into the normal braking operating state is only to be carried out, for example, if a corresponding authentication and verification of the authorization to cancel the separating operating state is carried out via authentication unit 60. As soon as a user has given the user's authorization to cancel the separating operating state via authentication unit 60, this is communicated as a signal via control and measuring line 71 to evaluation and blocking control unit 70, which, after evaluation via control and measuring line 73, energizes control valve 50 and/or control valve 90 and thus enables a return flow of brake fluid 37 from third or blocking compartment 41-3 of housing 41 of volume flow slider 40 via bypass line 51 back into reservoir 36 and/or via control line 51-5 into pressure accumulator 95.

As a consequence thereof, slide element 42 assumes the position shown in FIGS. 3 and 5 under the effect of the restoring force of restoring element 45, so that braking system 30 returns into the normal braking operating state.

Brake disk 34 is released from brake pads 33-2 of brake 33, corresponding wheel 9-1, 9-2 can again be rotated freely.

FIGS. 5 and 6 show in greater detail the operating states of volume flow slider 40 schematically indicated in FIGS. 3 and 4, the operating state shown in FIG. 5 corresponding to the normal braking operating state of braking system 30, and, in contrast, the state of volume flow slider 40 shown in FIG. 6 corresponding to the separating operating state of underlying braking system 30.

In FIGS. 3-6, a compensation opening 48 opposite to control opening 47 is also shown, which permits the pressure compensation in first or compensation compartment 41-1 of housing 41 of volume flow slider 40 and thus improves the mobility of slide element 42 in the interior of housing 41.

These and further features and properties of the present invention are explained further on the basis of the following demonstrations. Many bicycles 1 presently have hydraulic braking systems 30 in the form of disk brakes 33, namely having a brake caliper 33-1, brake pads 33-2, and a brake disk 34, since these types of brakes exhibit a good braking behavior. It is possible in principle using a control unit to actively reduce or increase the pressure in the corresponding hydraulic system and in particular in brake line 32 in order to enhance the riding comfort and the riding safety for the rider. A pressure reduction can be used, for example, to prevent flipping over handlebars 17 and a wheel 9-1, 9-2 from locking up during a hazardous situation. For example, a brake assist, which actively brakes a wheel 9-1, 9-2, and a theft protection by locking wheels 9-1, 9-2 can be implemented using a pressure increase. Such an active pressure control is limited for the following reasons, however.

The seals of brake lever unit 31, 36 and especially the seals of brake fluid reservoir 36 limit the maximum pressure, since these components are not explicitly designed for high pressures. At the same time, a relatively large hydraulic volume is required for active pressure control, since the air in compensation volume 38, which is located above the seal in brake fluid reservoir 36, first has to be displaced before a pressure can build up in the braking system and in particular in brake line 32. For safety reasons, normally-open valves (NOVs) have been previously installed, which effectuate this separation, i.e., valves which are open in the normal state or deenergized state and effectuate a hydraulic connection and have to be energized for a separation. A disadvantage of these valves in the form of NO-solenoid valves is the high power consumption which results in the event of a long-term separation.

It is an object of the present invention, in a hydraulic braking system 30, to hydraulically separate brake lever unit 31, 36, including brake fluid reservoir 36, from actual brake 33 and in particular from brake caliper 33-1, as shown in detail in FIGS. 3 and 4. For this purpose, according to the present invention, a combination is used of a (i) hydraulic valve 40, in particular in the form of a volume flow slider or a piston valve, (ii) two control valves 50, 90, and (iii) a pressure accumulator 95.

An overpressure is applied to a slide element 42, which is also referred to as a piston and which is thus linearly displaced in housing 41, namely from a right position in FIG. 3 to a left position in FIG. 4 in housing 41. Therefore, by interrupting actual brake line 32, brake lever unit 31, 36 is hydraulically separated from actual brake 33. A better pressure control directly at brake caliper 33-1 of brake 33 is possible due to this hydraulic separation. At the same time, the components of brake lever unit 31, 36 are not also loaded by the pressure.

Due to the separation from brake lever unit 31, 36, significantly less hydraulic volume is required for a pressure increase at brake caliper 33-1, since the air displacement in brake fluid reservoir 38 is completely omitted.

According to an aspect of the present invention, a hydraulic system in the sense of a hydraulic brake control unit 100 is provided, which is integrated into the brake circuit of a hydraulic braking system 30 and in particular into its brake line 32.

FIG. 3 shows a base state of an example embodiment of hydraulic braking system 30 according to the present invention using such a system. An evaluation and control unit 70, which is also referred to as a controller, evaluates different sensor signals and controls the opening times of the two NC-solenoid valves 50 and 90 accordingly.

If pressure is applied to hydraulic valve 40, piston 42 shifts from the right position 41 according to FIG. 3 to the left position in housing 41 according to FIG. 4, which results in the separation of brake line 32 of the brake circuit. This separated state is thus shown in FIG. 4. As long as the control pressure is applied to hydraulic valve 40, piston 42 remains in this position on the left side of the housing 41 according to FIG. 4. The control of the pressure at brake calipers 33-1 can take place in this state of the separation via the two control valves 50 and 90.

If the control pressure decreases, piston 42 is pressed by a restoring spring 45 back into the base position, i.e., to the right side in housing 41 according to the state shown in FIG. 3. Braking system 30 subsequently again functions in the conventional form as a hydraulic brake.

One advantage of the present invention is that electrical energy is only required for the linear displacement of piston 42 and for the pressure control by the two control valves 50 and 90. If control valves 50 and 90 are closed, piston 42 remains in the position in which it previously was. Therefore, in addition to a brake assist which controls the brake pressure during brake application, the blocking of wheels 9-1, 9-2 at a standstill over a specific time period as an additional protection from theft is implementable using this system.

The system provided here can fulfill, inter alia, two functions, namely (1) a better pressure control at brake caliper 33-1 during travel by hydraulic separation from brake lever unit 31, 36 and (2) blocking of wheels 9-1, 9-2 over a specific time period, without losing energy.

During travel, controller 70 permanently receives items of information from the sensors—for example, pressure sensors 55 and 57 or further sensors for describing the operating state of underlying vehicle 1—about the present travel situation. If the sensors detect a hazardous braking situation, controller 70 opens second control valve 90 as a normally-closed valve (NCV). Valve piston 42 of hydraulic valve 40, as is apparent in FIG. 4, is thus displaced in housing 41 to the left side. Brake line 32 is thus hydraulically interrupted and brake lever unit 30, 36 is hydraulically separated from actual brake 33, in particular from brake caliper 33-1.

As soon as brake caliper 33-1 is hydraulically connected to pressure accumulator 95, the two pressures equalize. The brake pressure in brake caliper 33-1 thus decreases. Excess braking and thus flipping over the handlebars or blocking of a wheel 9-1, 9-2 are prevented by the reduction of the brake pressure.

By opening first control valve 50, the brake pressure can be increased again as long as a higher pressure is applied to brake lever 31.

Due to this interplay between pressure buildup and pressure reduction at brake caliper 33-1, it is possible to adapt the brake pressures and thus the brake force distribution to the present braking situation to ensure a preferably safe brake application.

If bicycle 1 is parked, both wheels 9-1, 9-2 can be blocked either via a button press or automatically to prevent bicycle 1 from being pushed away unintentionally.

Controller 70 opens second control valve 90. This in turn results in a displacement of valve piston 42 in housing 41 and to the left side therein, as shown in FIG. 4.

Brake lever unit 31, 36 is again hydraulically separated from actual brake 33 and from brake caliper 33-1 thereon due to this displacement.

The pressure from pressure accumulator 95 subsequently ensures a pressure increase at brake caliper 33-1 upon connection. This results in the blocking and thus the stopping of wheels 9-1, 9-2.

If second control valve 90 is closed again, the pressure at brake caliper 33-1 is thus maintained without additional energy being required for this purpose.

To cancel out the blockade of wheels 9-1, 9-2 again, first control valve 50 is opened by controller 70.

The pressure gradient in the direction of brake lever 31 results in the reduction of the pressure at brake caliper 33-1. If this pressure drop is not sufficient, second control valve 90 thus also has to be opened and pressure accumulator 95 has to be charged by pumping on brake lever 31. This results in a pressure reduction in brake fluid 37 in the brake circuit and in particular brake line 32.

If the pressure reduction is large enough, valve piston 42 is thus pressed by restoring spring 48 in housing 41 into the starting position on the right side in housing 41 according to FIG. 3.

The brake circuit and brake line 32 are thus hydraulically connected again and brake 33 is fully functional.

1-13. (canceled)

14. A separating device for a hydraulic braking system, the separating device comprising:
a pressure accumulator; and
a hydraulic valve that includes a housing and a slide element and that is configured to displace the slide element in the housing from a first position to a second position in response to a pressure prevailing in the pressure accumulator, wherein:
when the slide element is in the first position, a first section of a brake line, which is at a reservoir side of the brake line, and a second section of the brake line, which is at a brake side of the brake line, are hydraulically connected to each other; and
when the slide element is in the second position, the first and second sections of the brake line are hydraulically separated from each other.

15. The separating device of claim 14, wherein the hydraulic valve is a volume flow slider or as a piston valve.

16. The separating device of claim 14, wherein:
the housing includes a first main opening located at a reservoir side of the housing and a second main opening located at a brake side of the housing;
in the first position of the slide element, the first and the second main openings of the housing are hydraulically connected to each other; and
in the second position of the slide element, the first and the second main openings of the housing are hydraulically decoupled from each other.

17. The separating device of claim 14, wherein the housing includes a control opening for a hydraulic control of the displacement of the slide element.

18. The separating device of claim 17, wherein the control opening controls a hydraulic connection and separation between the housing and the pressure accumulator.

19. The separating device of claim 18, further comprising a control line by which the connection and separation between the housing and the pressure accumulator via the control opening is controlled.

20. The separating device of claim 17, further comprising:
a control valve configured to control a hydraulic connection between the control opening and the first section of the brake line.

21. The separating device of claim 20, further comprising a bypass line that opens into the first section of the brake line, that is hydraulically connectable to the control opening of the hydraulic valve, and via which the control valve is configured to the control the hydraulic connection between the control opening and the first section of the brake line.

22. The separating device of claim 20, wherein the control valve is a normally-closed valve.

23. The separating device of claim 22, wherein the control valve is a de-energized closed solenoid valve.

24. The separating device of claim 17, further comprising:
a control valve configured to control the hydraulic connection between the control opening and the pressure accumulator.

25. The separating device of claim 24, further comprising a control line via which the control valve is configured to control the hydraulic connection between the control opening and the pressure accumulator.

26. The separating device of claim 24, further comprising a bypass line that opens into the first section of the brake line, that hydraulically connectable to the control opening, and via which the control valve is configured to control the hydraulic connection between the control opening and the pressure accumulator.

27. The separating device of claim 24, further comprising:
a bypass line that opens into the first section of the brake line and that hydraulically connectable to the control opening; and
a control line, wherein the control valve is configured to control the hydraulic connection between the control opening and the pressure accumulator via the bypass line and the control line.

28. The separating device of claim 24, wherein the control valve is a normally-closed valve.

29. The separating device of claim 28, wherein the control valve is a de-energized closed solenoid valve.

30. The separating device of claim 14, further comprising:
one or more control valves; and
a control unit, wherein the control unit is configured to control the displacement using the one or more control valves.

31. The separating device of claim 14, further comprising:
a control unit, wherein the control unit is configured to control the displacement based on signals of one or more sensors.

32. The separating device of claim 14, further comprising an authentication unit via which a cancellation of a state in which the slide element is in the second position is inputtable by a user.

33. The separating device of claim 32, wherein the authentication unit includes one or more of a WLAN unit, a Bluetooth unit, an RFID unit, a PIN input unit, a password protection unit, a biometric feature input unit.

34. The separating device of claim 32, wherein the authentication unit cancellation is inputtable via one or more of ultrasound, infrared, and radio communication.

35. The separating device of claim 32, wherein the authentication unit cancellation is inputtable via a mobile telephone.

36. The separating device of claim 14, wherein the hydraulic system is of a vehicle.

37. The separating device of claim 14, wherein the hydraulic system is of a bicycle, electric bicycle, e-bike, or pedelec drivable using one or both of muscular power and motor power.

38. A hydraulic braking system for a vehicle, the braking system comprising:
a reservoir for a brake fluid;
a brake;
a brake line for hydraulically connecting the reservoir to the brake; and
a separating device that includes:
a pressure accumulator; and
a hydraulic valve that includes a housing and a slide element and that is configured to displace the slide element in the housing from a first position to a second position in response to a pressure prevailing in the pressure accumulator;
wherein:
when the slide element is in the first position, a first section of the brake line, which is at a reservoir side of the brake line, and a second section of the brake line, which is at a brake side of the brake line, are hydraulically connected to each other; and
when the slide element is in the second position, the first and second sections of the brake line are hydraulically separated from each other.

39. A vehicle comprising:
at least one wheel; and
a braking system for braking the at least one wheel and including:
a reservoir for a brake fluid;
a brake;
a brake line for hydraulically connecting the reservoir to the brake; and
a separating device that includes:
a pressure accumulator; and
a hydraulic valve that includes a housing and a slide element and that is configured to displace the slide element in the housing from a first position to a second position in response to a pressure prevailing in the pressure accumulator;
wherein:
when the slide element is in the first position, a first section of the brake line, which is at a reservoir side of the brake line, and a second section of the brake line, which is at a brake side of the brake line, are hydraulically connected to each other; and
when the slide element is in the second position, the first and second sections of the brake line are hydraulically separated from each other.

40. A method for operating a hydraulic braking system, the method comprising:
displacing a slide element within a housing of a hydraulic valve between a first position and a second position in dependence upon a pressure prevailing in a pressure accumulator, wherein:
when the slide element is in the first position, a first section of a brake line, which is at a reservoir side of the brake line, and a second section of the brake line, which is at a brake side of the brake line, are hydraulically connected to each other; and
when the slide element is in the second position, the first and second sections of the brake line are hydraulically separated from each other.
